(19) United States
(12) Patent Application Publication
(10) Pub. No.: US 2017/0043345 A1
(43) Pub. Date: Feb. 16, 2017

(54) DEVICE FOR PREPARING A SUBSTRATE FOR PROCESSING SAMPLES

(71) Applicant: Tethis S.P.A., Milano (IT)

(72) Inventors: Dario BANDIERA, Olgiate Olona (IT); Emanuele BARBORINI, Pizzighettone (IT); Gian Martino FRANCHI, Cislago (IT); Massimo GATELLI, Gussago (IT)

(73) Assignee: TETHIS S.P.A., Milano (IT)

(21) Appl. No.: 15/118,733

(22) PCT Filed: Feb. 12, 2015
(86) PCT No.: PCT/EP2015/052951

§ 371 Date: Aug. 12, 2016

(30) Foreign Application Priority Data
Feb. 12, 2014 (EP) 14154871.9

(51) Int. Cl. B01L 9/00

(52) U.S. Cl. CPC B01L 9/52; B01L 2200/025; B01L 2200/0689; B01L 2300/0816; B01L 2300/0822; B01L 2300/0887; B01L 2300/123

(57) ABSTRACT

A device (1) for preparing a substrate (S) for processing samples comprises at least a cover (3) having a contact surface (3a) configured to come into contact with a substrate (S) and sealing means (4) located on the contact surface (3a) for latching onto the substrate (S), the cover (3) has a peripheral rim (3b) and an aperture (5) for handling fluids; a frame (6) having an engagement surface (6a) to be coupled with the substrate (S) and at least a window (7) into the engagement surface (6a), said window (7) having an edge (7a) to engage the rim (3b) for holding said cover (3) in a predetermined position with respect to the frame (6).

### FIELD OF THE INVENTION

The present invention relates to a device for preparing a substrate for processing samples. Such device is preferably of the disposable kind. Specifically, the present invention is particularly useful in the field of laboratory processing of samples, particularly of biological assays. Some of the tests that can be aided by a device according to the invention are FISH (Fluorescent in Situ Hybridization), hematochemical tests, PCR (Polymerase Chain Reaction), ELISA (Enzyme-Linked ImmunoSorbent Assay) and immunohistochemical tests in general.

### PRIOR ART

In the known prior art, an assay device for the above mentioned tests is assembled by hand. The assay device comprises a substrate which can be, for example, a glass slide. A cover is provided with a cavity for sample processing and with an aperture in fluid communication with the cavity. This cover can be, for example, a silicone pad. The cover is then pressed onto the slide so that the cavity defines, together with the glass slide, a chamber for sample processing. In order to actually perform the test, the slide with the cover have to be manually placed by an operator inside a machine, such as a liquid handling robotic platform, having care to align the apertures of the cover with fluid-handling means provided by the machine.

The main disadvantage of the prior art is that the positioning of the cover on the glass slide cannot be guaranteed with adequate precision. As a matter of fact, since each assay device is assembled individually by hand, the placement of the cover in terms of position of its apertures with respect to the slide borders, changes from one slide to the next.

Another disadvantage is the variability of the size of the glass slide, at least due to tolerances on dimensions related to slides production process. Indeed, even when glass slides of standard size are used, the substrate dimensions may have a variability up to 1 mm. Therefore, even if some kind of automatic system were to be used in the positioning of the cover on the slide, a sufficiently precise accuracy would be impossible when taking the border of the slide itself as reference.

Due to these two factors, it is impossible to repeatedly and successfully perform the tests automatically, since the machine would often miss the aperture and would therefore be unable to handle the assay fluids inside the chamber.

### SUMMARY

The purpose of the present invention is therefore to provide a disposable device for preparing a substrate for processing samples that can overcome the above mentioned disadvantages.

Indeed, the technical problem solved by the present invention is to provide a device that can prepare a substrate which can be subsequently handled in a fully automatic way.

The device according to claim 1 solves the technical problem. Indeed, the frame allows to apply the covers onto the substrate in such a way that the position of the covers relative to the frame is known with the required precision. By handling the entire assembly (frame, cover and slide) and by knowing the position of the aperture on the cover with respect to the frame, the size of the substrate and the precise positioning of the covers on the slide become irrelevant, assuming that the overall maximum dimensions in the plane are smaller than those of the frame.

Indeed, by taking the frame itself as a reference it is possible to have a relative alignment between the aperture and the fluid handling means provided by the machine with a precision up to 0.05 mm. Therefore the machine can be used to automatically handle the fluids used in the assay, including, if necessary, the sample itself.

A further advantage of the invention is the versatility, as the frame can be configured with any number of windows, which can be adapted in size depending on the particular application.

Also, the receptacle mentioned in claim 11 allows to limit human error in assembling the device with the substrate, thus leading to a correct positioning and, as a consequence, to a correct liquid dispensing by the automated system, so preventing test failure.

Another advantage is the reversible adhesion of the device to the substrate, permitting the removal of the device itself at the end of the assay and the standard evaluation of the substrate (e.g. by optical microscope). The device can then disposed of to avoid any cross contamination, like in reusable systems.

Furthermore, the use of a detaching tool allows to reduce handling, thus reducing the risk of damage for the components (rupture, contamination, displacement) and reducing the risk of injuries for the operator (when using frail and potentially sharp-when-broken components like glass slides).

Additionally, this kind of device allows to add specific features such as an in situ water reservoir in order to increase local humidity conditions, which is a critical parameter for some kinds of cytogenetic tests. These changes can be made during assembling at the factory, thus leading to increased production flexibility, or by the operator himself.

Furthermore, using a rigid frame as a position reference advantageously allows compensating for most variations in substrate dimensions. Indeed, the frame can be used as fixed reference in the plane of the engagement surface, instead of the substrate itself.

As an additional advantage, a certain degree of mobility of the cover is allowed in the direction perpendicular to the engagement surface of the frame. Indeed, allowing a certain degree of freedom to parts of the cover allows to compensate the surface forces that can be created from an uneven adhesion of the flexible parts to the substrate. In turn, this leads to a more stable adhesion between flexible part and substrate.

Furthermore, this advantageously helps to compensate superficial irregularities on the slide (for example due to micropatterning or to the presence of non-perfectly-planar biological material like solid tissue samples).

### DESCRIPTION OF THE DRAWINGS

Further features and advantages of the invention will therefore become clear from the following non-limiting description of a preferred embodiment, as shown in the attached drawings in which:

FIG. 1a is a perspective view of a first embodiment of a device for preparing a substrate for processing samples;

FIG. 1b is a side view of the embodiment from FIG. 1a;

FIG. 1c is a perspective view of a second embodiment of a device for preparing a substrate for processing samples;

FIG. 1d is a side view of the embodiment from FIG. 1c;

FIG. 2a is a perspective view of a third embodiment of a device for preparing a substrate for processing samples;

FIG. 2b is a side view of the embodiment from FIG. 2a;

FIG. 3a is a perspective view of a fourth embodiment of a device for preparing a substrate for processing samples;

FIG. 3b is a side view of the embodiment from FIG. 3a;

FIGS. 4a, 4b are perspective views of a detail of the device according to the embodiment from FIGS. 3a and 3b;

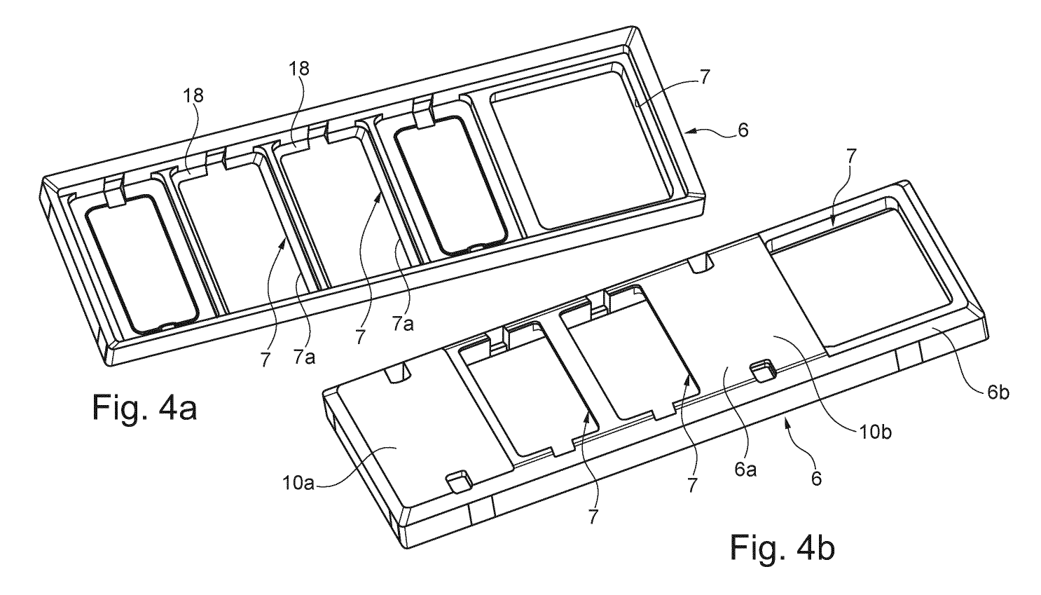

FIGS. 5a, 5b are perspective views of a further detail of the device according to the embodiment from FIGS. 3a and 3b; and

FIG. 6 is a perspective view of a first embodiment of a detaching tool that can be used with a device for preparing a substrate for processing samples according to any of the embodiments from the previous figures;

FIG. 7 is a perspective view of a second embodiment of a detaching tool that can be used with a device according to any of the embodiments from the previous figures.

### DETAILED DESCRIPTION

Referring to the attached drawings, with the numeral 1 is indicated a device for preparing a substrate “S” for processing samples.

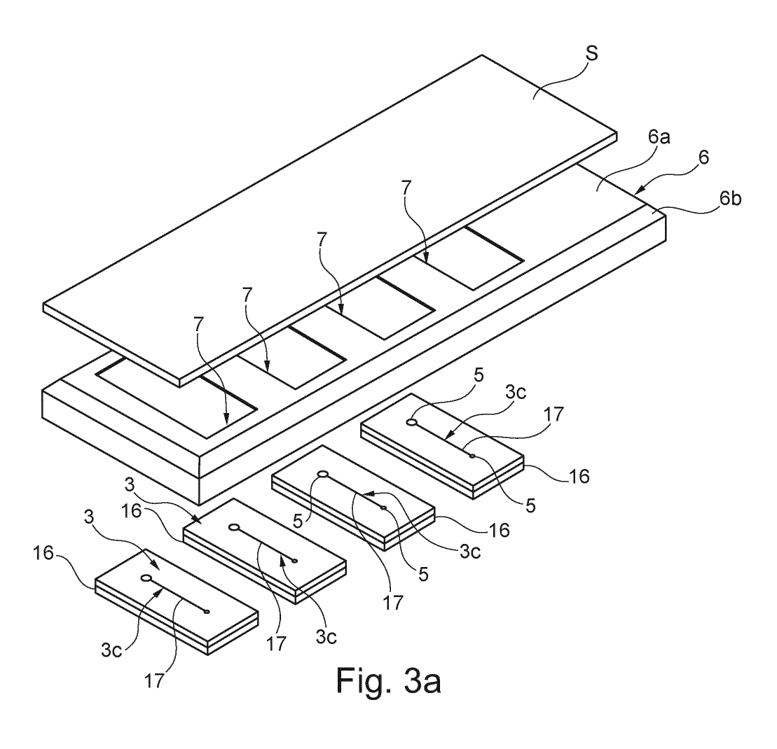

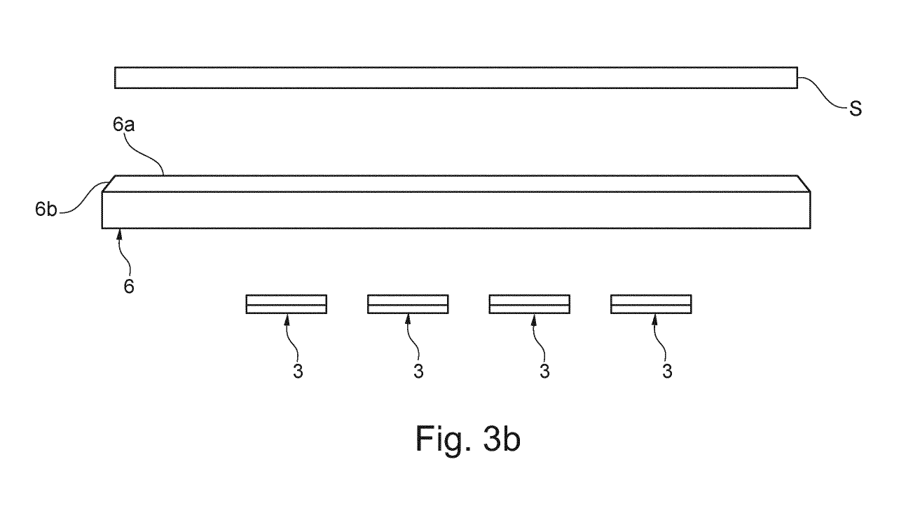

The device 1 comprises at least a cover 3. Indeed, according to the embodiment shown in FIG. 3a, the device 1 can comprise a plurality of covers 3. The cover 3 has the function to hold a sample, in particular a liquid containing a sample onto a substrate “S”. Such sample can be either in liquid or in solid form. An example of a solid sample can be a slice of formalin fixed paraffin embedded tissue sample.

The cover 3 can also hold the reaction fluids themselves onto the same substrate “S”. The samples can be either present (as in the case of formalin fixed paraffin embedded tissue samples) or not on the substrate before the assembling with the device. The substrate “S” is preferably a biocompatible substrate such as, for example, a silicon plate or a glass slide. The substrate “S” itself does not form part of the present invention. Accordingly, any known substrate suitable for a specific test can be used as the substrate “S” mentioned in the present disclosure. Indeed, the cover 3 has preferably a planar or quasi-planar shape. For example, the cover 3 can comprise areas exerting from the base plane of the cover 3 itself. Also, the cover 3 can be partially or totally transparent, in order to allow an assay to be performed on the sample on the underlying substrate. As an alternative the cover 3 can be totally opaque in order to screen the sample from visible light.

The device 1 also comprises a frame 6. Such frame 6 is configured to hold the cover 3 so that it can be applied to the substrate “S”. The overall maximum dimensions in the plane of the frame 6 are bigger than those of the substrate “S”.

Specifically, the frame 6 has an engagement surface 6a, which is configured to be coupled with the substrate “S”. This means that, when the device 1 is applied to the substrate “S”, the engagement surface 6a is very close or in contact with the substrate “S”. It is to be noted that the engagement surface 6a can either be a physical surface on the frame 6, for example if the frame 6 has a planar or substantially planar wall which, in use, faces the substrate “S”. In case of a more complex geometry of the frame 6, the engagement surface 6a can just be a geometrical surface that is defined in relation to a particular reference feature of the frame 6. It is also to be noted that by the word “coupled” is meant that the engagement surface 6a is, in use, close to the substrate “S”. However, it is not necessary for the engagement surface 6a to enter in contact with the substrate “S”.

The frame 6 can be either of a metallic or polymeric material. In the preferred embodiments, the frame 6 is made from a polymeric material, preferably from moulded thermoplastic compound. More details will be given in a following part of the present disclosure.

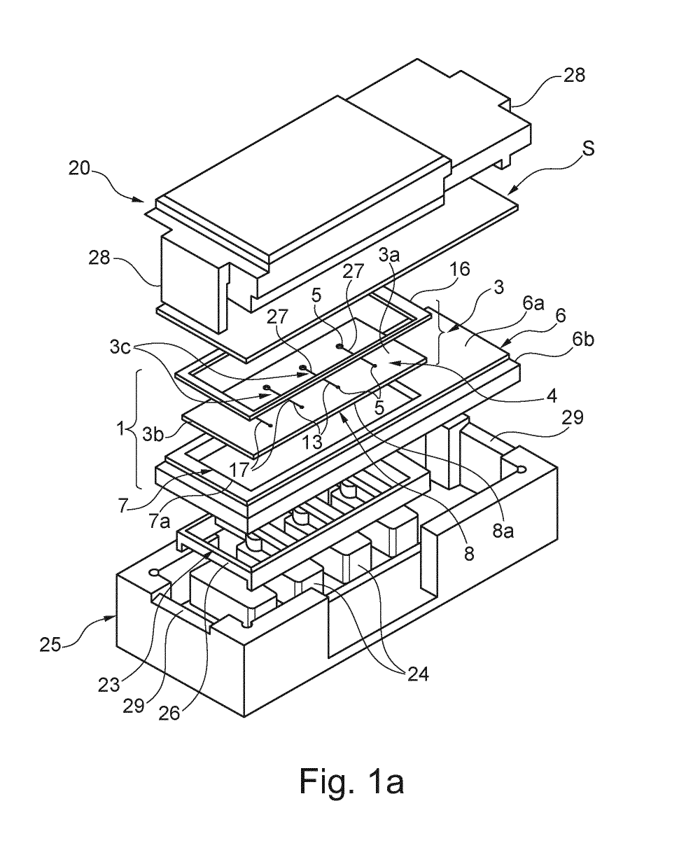

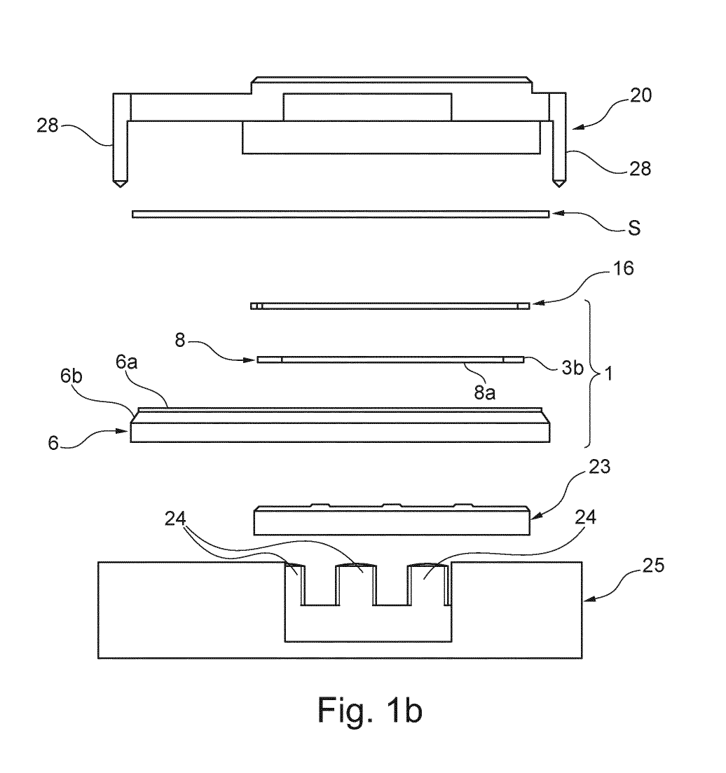

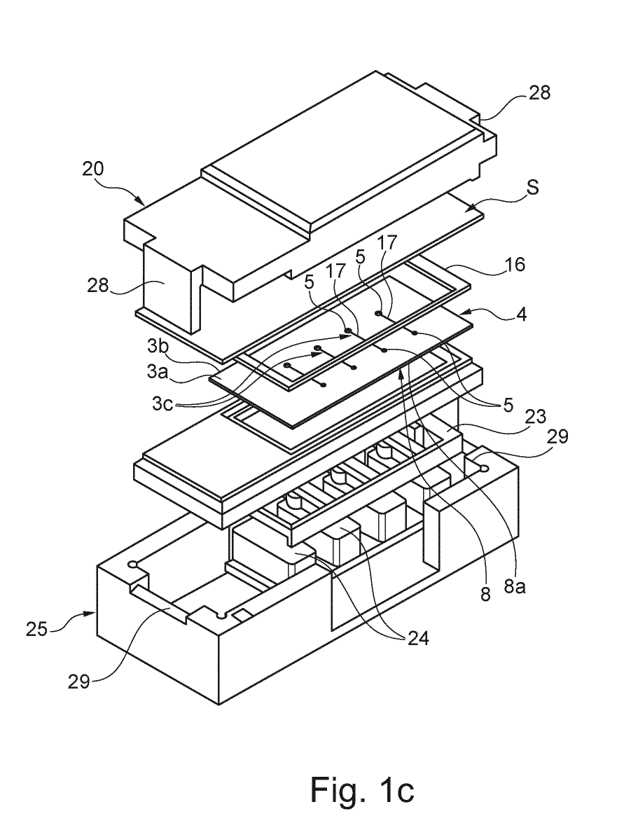

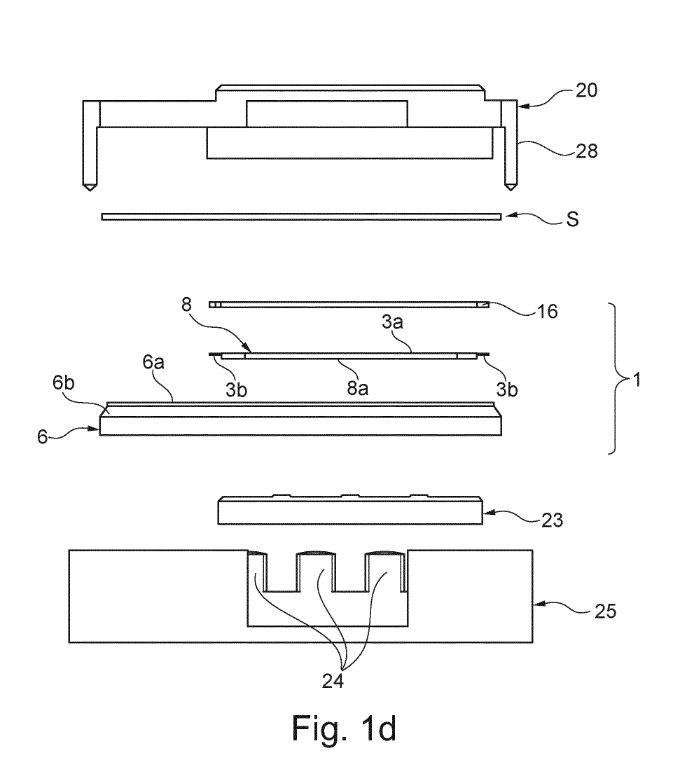

With additional detail, the cover 3 has a contact surface 3a configured to come into contact with the above mentioned substrate “S”. The cover 3 has also a peripheral rim 3b. In the context of the present disclosure, the term “rim” is meant as the planar border of the cover 3. Specifically, the rim 3b may or may not be of the same material as the rest of the cover 3. Indeed, the cover 3 may be of a single, continuous material such as, for example, silicone. In this case the rim 3b is the border of the silicone pad itself. In another embodiment, such as the one shown in FIG. 1a, the rim may be of a different material than the rest of the cover 3.

Further details will be given in a following part of the present disclosure.

The cover 3 also has at least an aperture 5 for handling fluids. Preferably, as shown for example in FIGS. 3a and 3b, the cover 3 has two apertures 5. Indeed, in the present disclosure two apertures 5 will be referenced as the preferred embodiment without incurring in any loss of generality. The cover 3 also has a cavity 3c that defines a chamber 13 together with the above described substrate “S”. The apertures 5 are therefore placed in fluid connection with the cavity 3c.

The apertures 5 and the chamber 13 define a processing area 27 in which an assay can be performed. A single cover 3 may have one or more processing areas 27.

Furthermore, the cover 3 comprises sealing means 4. Sealing means 4 can be located on the contact surface 3a for latching onto the substrate “S”. In the context of the present disclosure, the expression “sealing means” can designate any component with the capability to adhere to the substrate “S”. Therefore, the sealing means 4 can also be identified with the contact surface 3a of the cover 3 itself, provided that is made of a material that spontaneously adheres or that is treated in order to spontaneously adhere to the substrate “S”. Such material may be, for example PDMS (PolyDiMethylSiloxane) or silicone. Indeed, this is the case for all the embodiment shown in the figures.

More generally, the sealing means 4 comprise a self sealing area on the contact surface 3a, as described above. In alternative embodiments, not shown in the drawings, the cover 3 may be provided with separate sealing means 4. Therefore, the sealing means 4 may also be a coating of adhesive on the contact surface 3a of the cover 3. Alternatively, the sealing means can be clamps (not shown).

More in detail, the cover 3 comprises a flexible pad 8. Indeed, the pad 8 is joined to the rim 3b. Moreover, the pad 8 can be made as a single piece with the rim 3b, i.e. the rim 3b may be a part of the pad 8. In particular, the contact surface 3a is located onto the pad 8. The pad 8 also has an external surface 8a, which is opposite with respect to the contact surface 3a. Indeed, the previously mentioned apertures 5 are located on the external surface 8a of the pad 8. With more detail, the pad 8 can be substantially planar, and can have an average thickness comprised between 0.1 mm and 10 mm, preferably equal to 1 mm.

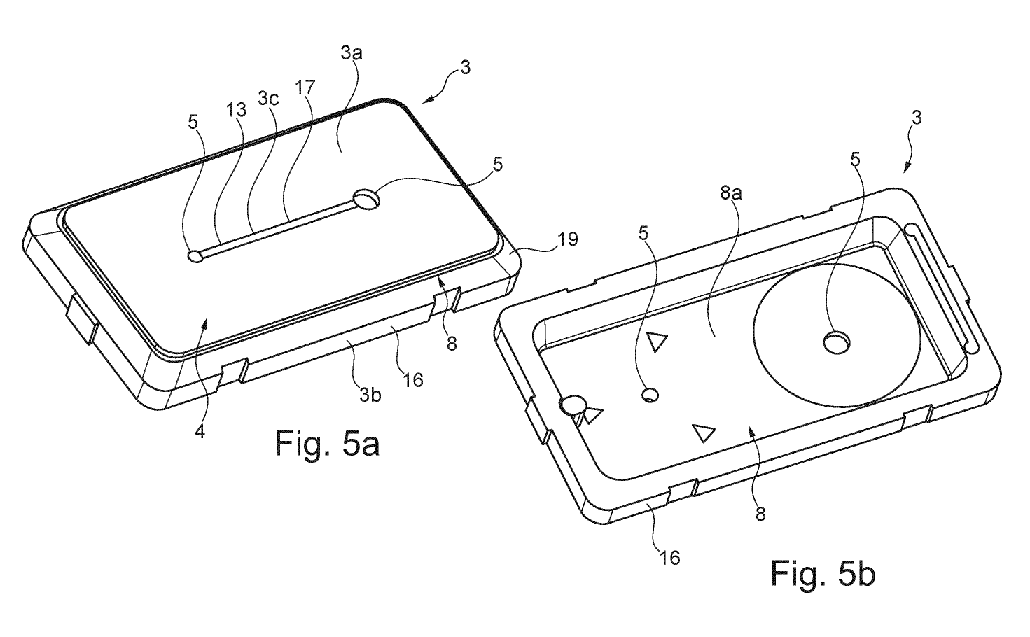

In the preferred embodiment, shown in detail in FIG. 5, the pad 8 is provided with a microchannel 17, which is a particular embodiment of the above mentioned cavity 3c. This microchannel defines the above mentioned chamber 13. Indeed, the microchannel 17 connects the two apertures 5 so that, in use, the fluids are inserted through one of the apertures 5, transit through the microchannel 17, and exit through the other aperture 5. Such arrangement is by itself known in the field of microfluidics, and will not therefore be further detailed in the present disclosure.

According to an embodiment of the present invention, the rim 3b is substantially rigid. In other words, the rim 3b can act as support for the entire cover 3, in particular for the flexible pad 8. Indeed, the rim 3b can act as a frame for the pad 8. As shown for example in FIGS. 3a, the cover 3 may comprise a ring 16, located on the rim 3b, in order to make the rim 3b rigid. The ring 16 can be either of a metallic or polymeric material. In the preferred embodiments, the ring 16 is made from a polymeric material, preferably from molded thermoplastic compound.

In another embodiment of the invention like the one shown in FIGS. 1c and 1d, the rim 3b of pad 8 is soft. Therefore, the rim 3b can be pressed between the ring 16 and the above cited frame 6 in order to fix the position of the pad 8 with respect to the engagement surface 6a of frame 6. As an alternative the rim 3b can be stuck on the above cited frame 6. Indeed, slight position adjustments in the direction perpendicular to the engagement surface 6a of frame 6 are allowed, thus allowing a tilting movement. A suitable rim 3b can have thickness lower than half the thickness of pad 8, for example comprised between 0.1 mm and 5 mm, preferably equal to 0.5 mm.

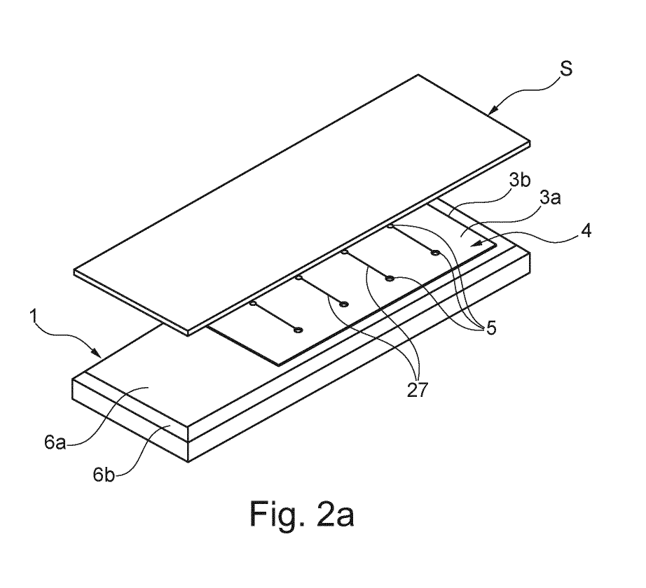

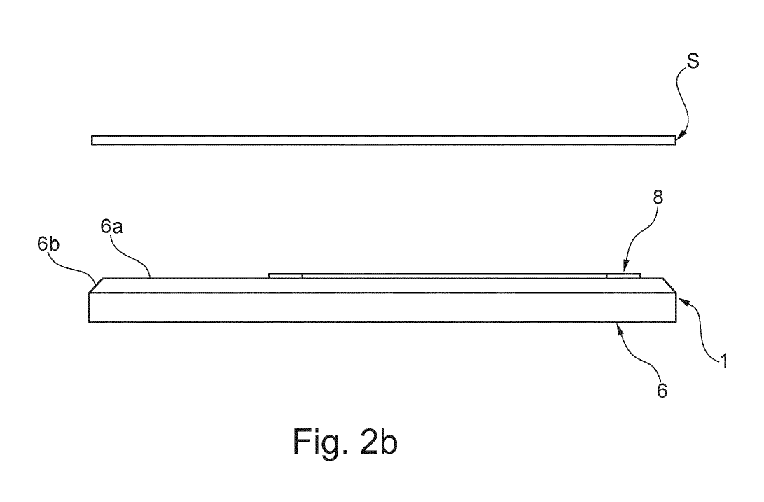

In the embodiments of the invention shown for example in FIGS. 2a and 3a, the rim 3b and the pad 8 are comoulded. Comoulding, overmoulding, “2k moulding” and “2k injection moulding” are synonyms for the purposes of the present patent application. Advantageously, this increases the level of precision during the assembly of the cover 3. Indeed, even when they are made of different materials, the pad 8 and the rim 3b can be formed as a unique element in an automatized way. For this reason, the assembly operation is not affected by imprecise manual handling.

With greater detail, in the embodiments shown in the figures the frame 6 has a substantially rectangular shape. Preferably, the engagement surface 6a is provided with rounded external edges 6b. Advantageously, these rounded edges 6b create a gap around the border of the substrate “S” in order to facilitate the separation of the substrate “S” from the device 1.

The frame 6 has at least a window 7 into its engagement surface 6a. The window 7 has an edge 7a configured to engage the rim 3b in order to hold the cover 3 in a predetermined position with respect to the frame 6. In such predetermined position the engagement surface 6a of the frame 6 and the contact surface 3a of the cover 3 lay on planes substantially parallel or coplanar. Specifically, this predetermined position is substantially fixed with respect to the engagement surface 6a of the frame 6. Also, the cover 3 may be fixed onto the frame 6 as in the embodiment from FIG. 2a. Alternatively, the cover 3 may be detachable from the frame 6, as for example in the embodiments from FIGS. 1a and 3a.

It is to be noted that the cover 3 can be either permanently or semi-permanently lodged into the window 7 or, alternatively, it can be detachable from the frame 6.

In the first case, the edge 7a of the window 7 can actually be fixed to the rim 3b of the cover 3.

One or more of the windows 7 can be closed by a top. Such top can be in the form of a detachable top 10a or of a permanently or semi-permanently lodged top 10b.

Further types of elements can be mounted in windows 7 in place of cover 3 or tops 10a or 10b, such as bar code supports and liquid reservoirs (not shown in the attached drawings).

The edge 7a of the window 7 is provided with at least an abutment 18. The cover 3 has a supporting surface 19, which is configured to rest onto the abutment 18.

Therefore, in use, the abutment 18 of the window 7 is locked between the supporting surface 19 of the cover 3 and the substrate “S” itself. Advantageously, this allows to keep the frame 6 attached to the substrate “S”, even without direct permanent contact between the frame 6 and the substrate “S”.

More precisely, in the predetermined position the distance between the supporting surface 19 and the substrate “S” is greater than a thickness of the abutment 18. In other words, if the engagement surface 6a of the frame 6 and the contact surface 3a of the cover 3 are substantially coplanar, the supporting surface 19 is detached from the abutment 18. Therefore, a slight movement of the cover 3 with respect to the frame 6 is allowed, only along a direction perpendicular to the engagement surface 6a of the frame 6, thus allowing a tilting movement. Advantageously, this allows for slight adjustments of the position of the frame 6 on the substrate “S”, which are useful in case the engagement surface 6a is not sufficiently planar.

Indeed, this allows to compensate any bending in the structure of the frame 6.

Part of the present invention is also a kit comprising a device 1 as described above. The kit comprises a device 1 as described above. A receptacle 25 and an upper shell 20 are also provided in order to assemble the substrate “S” and device 1. With greater detail, the receptacle 25 is also configured to hold the frame 6, in order to align the frame 6 with the substrate “S”. Indeed, the receptacle 25 has the same planar shape of the frame 6. This allows to place the frame 6 into the predetermined position with respect to the substrate “S”, so that the above mentioned sealing means 4 can be activated in order to attach the cover 3 onto the substrate “S”.

The kit may also comprise one or more pressing portions 24, which are configured to contact the covers 3 when they are placed onto the frame 6. Additionally, a grid 23 can be placed inside the receptacle 25. The grid 23 has the function of holding the pressing portions 24 in a fixed position with respect to the receptacle 25 so that the surface of the pressing portions 24 can come into contact with the external surface 8a of the device 1. The upper shell 20 is also provided, which can be coupled with receptacle 25, as shown in fig. la for example.

Indeed, the upper shell 20 can be provided with appendages 28 that can be inserted into respective guides 29 carved into the receptacle 25. Once the substrate “S” is positioned in the receptacle 25 on top to the device 1 previously inserted in the same receptacle 25, it is possible to exert pressure on the upper shell 20 and on the receptacle 25. Therefore, the operator can force the sealing means 4 of the cover 3 to adhere to the substrate “S”, so securing the device 1 onto the substrate “S”. A biological assay can then be performed as described above. In a further embodiment, the pressing portions 24 are attached to the upper shell 20 instead that to the receptacle 25 through the use of attaching means like grid 23.

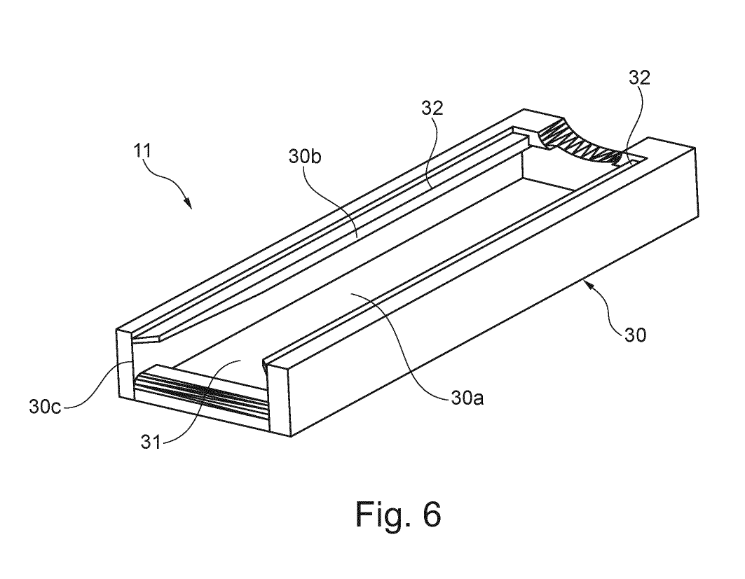

The kit may also comprise a detaching tool 11, such as the one shown in FIG. 6.

The detaching tool 11 has the purpose of separating the device 1 from the substrate “S”.

In a first embodiment, such detaching tool 11 comprises a handle 30 having a back wall 30a and a cavity 31. The cavity 31 has an internal width comparable with a width of the substrate “S”. The handle 30 has a first 30b and a second 30c open sides. The first open side 30b is opposite to the back wall 30a, while the second open side 30c is placed transversally to both the first open side 30b and to the back wall 30a.

The detaching tool 11 also comprises a pair of rails 32. These rails 32 are opposite to each other, and are placed on the first open side 30b of the handle 30. For detaching the substrate “S” from the device 1, the assembly is placed onto the handle 30. Specifically, in order to separate the substrate “S” from the device 1, the operator slides the rails 32 between the substrate “S” and the external edges 6b of the frame 6. Advantageously, the substrate “S” can then be placed into imaging instrumentation for assay evaluation.

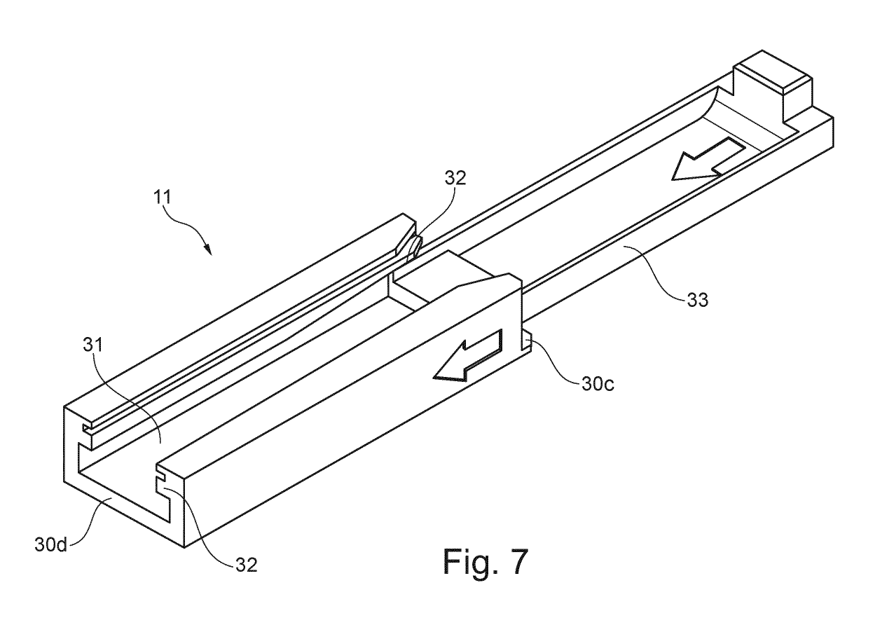

In a second embodiment, as shown in FIG. 7, such detaching tool 11 has a third open side 30d opposite to the second open side 3c. Such detaching tool 11 also comprises a sledge 33, which is inserted into the second open side 30c and slid towards the third open side 30d. For detaching the substrate “S” from the device 1, the assembly is placed onto handle 30 above the sledge 33. More specifically, the operator slides the sledge 33 inside the cavity 31, pushing the assembly so that rails 32 slide between the substrate “S” and the external edges 6b of the frame 6 in order to separate the substrate “S” from the device 1. Advantageously, the substrate “S” can then be retrieved from the upper part of handle 30 and placed into instrumentation for assay evaluation, for example imaging instrumentation.

Advantageously, the above mentioned detaching tool 11 allows to separate the substrate “S” from the cover 3, even when the adhesion between the cover 3 and the substrate “S” is very strong. In turn, this prevents injuries to the operator, since the substrate “S” commonly comprises a glass slide which can easily end up broken during by-hand separation of substrate “S” and device 1. Furthermore, using the detaching tool 11 reduces the need for the operator to touch parts of the device 1 and of the substrate “S”, thus reducing the risk of involuntary contaminating the assay results or to get into contact with biological samples or with residuals of chemical (and possibly dangerous) reactants.

In order to perform a biological assay the device 1 can be coupled with different kinds of substrate “S”, as explained above. A particularly advantageous substrate “S” is at least partially functionalized with a nanostructured metal oxide film.

Indeed, this can be applied on a conventional glass slide.

With the word “nanostructured” is meant that the film is made by the assembling of units, either crystalline or not, whose linear dimensions are between 1 and 100 nm.

1. Device for preparing a substrate for processing samples comprising at least a cover for a sample, said cover having a contact surface configured to come into contact with a substrate and sealing means located on said contact surface for latching onto said substrate, said cover having a peripheral rim and at least an aperture for handling fluids; the device also comprising a frame having an engagement surface configured to be coupled with said substrate and at least a window into said engagement surface, said window having an edge configured to engage said rim for holding said cover in a predetermined position with respect to the frame; characterized in that said contact surface is configured to reversibly come into contact with said substrate; said sealing means being defined by a self-sealing area on the contact surface of said cover, said contact surface being made of a material configured to spontaneously adhere to said substrate.

2. The device according to claim 1, characterized in that in said predetermined position the engagement surface of the frame and the contact surface of the cover lay on planes substantially parallel or coplanar.

3. The device according to claim 1, characterized in that said edge is provided with at least an abutment, said cover having a supporting surface configured to rest onto said abutment.

4. The device according to claim 3, characterized in that in said predetermined position, when the engagement surface of the frame and the contact surface of the cover are substantially coplanar, the supporting surface is detached from said abutment to allow a movement of the cover with respect to the frame along a direction perpendicular to the engagement surface of the frame.

5. The device according to claim 1, characterized in that said rim is substantially rigid.

6. The device according to claim 1, characterized in that said cover comprises a flexible pad joined to said rim.

7. The device according to claim 6, characterized in that pad and rim are comoulded.

8. The device according to claim 6, characterized in that said contact surface is located onto said pad, the pad also having an external surface opposite to said contact surface, the pad also having a cavity configured to define a chamber together with said substrate, said aperture being located on the external surface and being in fluid connection with said cavity.

9. Kit comprising a device for preparing a substrate for processing samples according to claim 1; a receptacle for holding said substrate, the receptacle being configured to hold said frame for aligning said frame to said substrate.

10. The kit according to claim 9, wherein said receptacle has the same planar shape of said frame.

11. The kit according to claim 9, characterized in that it comprises a detaching tool associated to said device and configured to separate the device from the substrate.

12. The device according to claim 7, characterized in that said contact surface is located onto said pad, the pad also having an external surface opposite to said contact surface, the pad also having a cavity configured to define a chamber together with said substrate, said aperture being located on the external surface and being in fluid connection with said cavity.

13. The kit according to claim 10, characterized in that it comprises a detaching tool associated to said device and configured to separate the device from the substrate.
